(19) United States
(12) Patent Application Publication
(10) Pub. No.: US 2007/0150754 A1
(43) Pub. Date: Jun. 28, 2007

(54) Secure software system and method for a printer

(76) Inventors: Steven J. Pauly, New Milford, CT (US); Robert G. Arsenault, Stratford, CT (US); Gary S. Jacobson, Norwalk, CT (US); George T. Monroe, Seymour, CT (US); Walter J. Baker, Stratford, CT (US); Wesley A. Kirschner, Farmington, CT (US); Robert W. Sisson, Trumbull, CT (US); Sung S. Chang, Stamford, CT (US); Elaine Cristiani, Stratford, CT (US)

Correspondence Address: PITNEY BOWES INC.;35 WATERVIEW DRIVE, P.O. BOX 3000, MSC 26-22, SHELTON, CT, 06484-8000, US

(21) Appl. No.: 11/317,464

(22) Filed: Dec. 22, 2005

(51) Int. Cl. G06F 12/14

(52) U.S. Cl. 713/193

(57) ABSTRACT

A postal security device (PSD) includes a microprocessor including an internal random access memory (RAM) and an internal flash memory in which is stored at least one secure datum, and at least one external memory coupled to the microprocessor in which is stored at least one non-secure datum and not one of the at least one secure datum.

### BACKGROUND OF THE INVENTION

1. Field of the Invention

The present invention relates generally to a system for partitioning the operation of software in a secure environment.

2. Background Information

Traditionally, microprocessor based systems requiring secure operation, such as a postal security devices (PSD), have had a significant cost associated with them. With reference to FIG. 1, there is illustrated a PSD 11 known in the art. As is evident, PSD 11 forms a self contained apparatus including an application specific integrated circuit (ASIC) 13, a tamper detection device 17, an environmental limit detection device 15, and a voltage monitor 19.

While illustrated schematically, tamper detection device 17 may in practice be any device or component configured to indicate a breech, either physical or electronic, of the PSD. Environmental limit detection device 15, operates to detect when the PSD is operating in a physical environment in excess of its design parameters, such as when the surrounding temperature exceeds a safe level. Voltage monitor 19 operates to maintain an acceptable voltage level absent possible voltage spikes. In addition, various other software components, such as programs performing cryptographic services, finance functions, indicia data generation, and audit functions, are stored on non-volatile media such as internal ROM and internal flash memory.

In addition, the PSD 11 includes additional volatile and non-volatile memory. The illustrated embodiment is therefore seen to make use of a variety of dedicated hardware components coupled to one another within a sealed environment providing security against outside tampering. Unfortunately, such a system can cost typically from seventy dollars to two hundred and fifty dollars.

What is therefore needed is a system for providing secure access to software and hardware components that does not require excessive physical sequestering and management of the components and which does not entail a high cost of production.

### SUMMARY OF THE INVENTION

In accordance with an exemplary embodiment of the invention, a postal security device (PSD) includes a microprocessor including an internal random access memory (RAM) and an internal flash memory in which is stored at least one secure datum, and at least one external memory coupled to the microprocessor includes at least one non-secure datum and does not include one of the at least one secure datum.

In accordance with another exemplary embodiment of the invention, a method of securing at least one secure datum in a postal security device (PSD) includes storing the at least one secure datum in an internal flash memory, and storing at least one non-secure datum in an external memory coupled to the microprocessor wherein none of the secure data is stored in the external memory.

In accordance with another exemplary embodiment of the invention, an apparatus includes a first microprocessor comprising an internal random access memory (RAM) and an internal flash memory in which is stored at least one secure datum the first microprocessor coupled to at least one external memory in which is stored at least one non-secure datum and none of the at least one secure datum, and a second microprocessor comprising an internal RAM and an internal flash memory in which is stored at least one secure datum the second microprocessor coupled to at least one external memory in which is stored at least one non-secure datum and none of the at least one secure datum wherein the first microprocessor is coupled to the second microprocessor.

### BRIEF DESCRIPTION OF THE DRAWINGS

The foregoing aspects and other features of the present invention are explained in the following description, taken in connection with the accompanying drawings, wherein:

FIG. 1 is a diagram of a postal security devices (PSD) known in the art.

FIG. 2 is a diagram of an exemplary embodiment of an apparatus of the invention.

FIG. 3 is an exemplary embodiment of derivatives of a data component according to the invention.

FIG. 4 is an exemplary embodiment of a method of the invention.

FIG. 5 is an exemplary embodiment of a configuration of an apparatus of the invention.

FIG. 6 is an exemplary embodiment of a configuration of an apparatus of the invention.

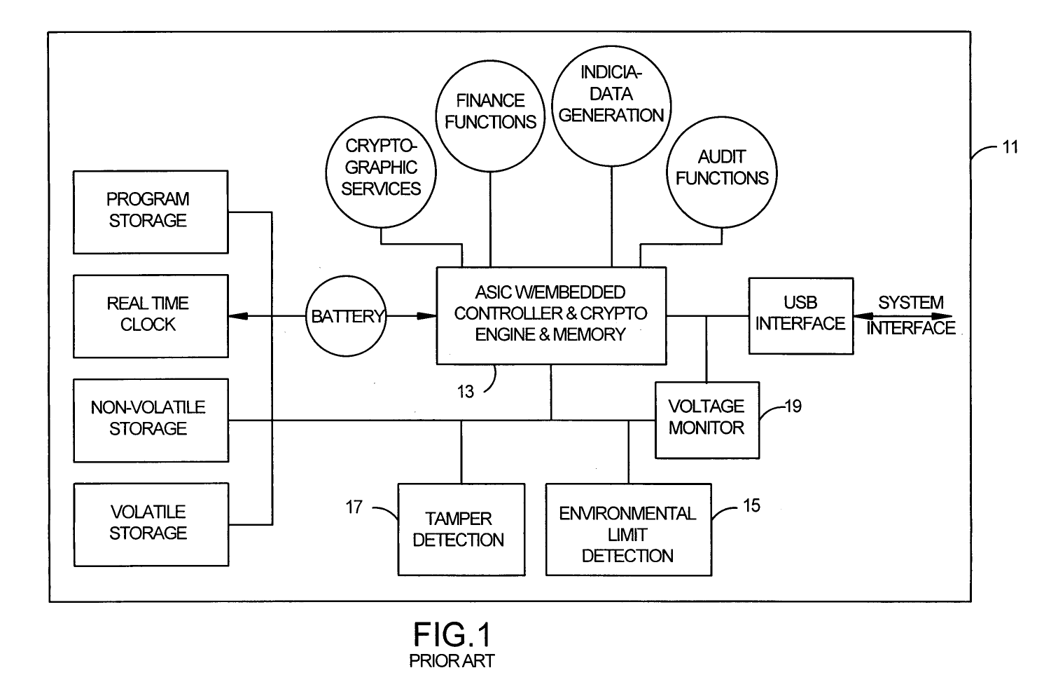

### DETAILED DESCRIPTION

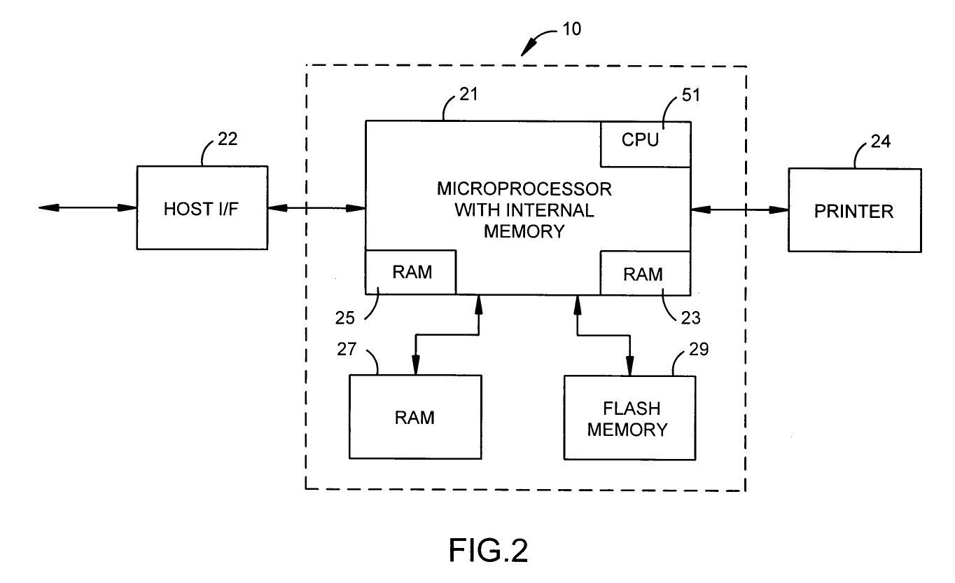

In exemplary embodiments of the invention, there is provided a apparatus, preferably a postal security device (PSD), and method for using the apparatus, that provides both a high level of security and a low production cost. Referring to FIG. 2, there is shown a diagram of an exemplary embodiment of a system 10 for practicing the invention. A microprocessor 21 having internal flash memory 23 and internal random access memory (RAM) 25 is utilized to store secure data. As used herein, “secure data” refers to data and computer code the access to which is controlled. External RAM 27 and external flash memory 29 are coupled to the microprocessor 21. Microprocessor 21 is further coupled to a host interface 22 and a printer 24. In an exemplary embodiment of the invention, the system 10 forms a part of a PSD. There is therefore provided a system 10 configuration whereby data and software can be partitioned. Specifically, secure data, data which must be protected from unauthorized observation, is partitioned to reside within a microprocessor 21 while non-secure data can reside external to and coupled to the microprocessor 21.

As noted, the microprocessor 21 is formed of internal memories 23, 25. Specifically, an internal flash memory 23 and an internal RAM 25 are located internal to microprocessor 21. By “internal” it is meant that the memories 23, 25 are fabricated to form an integral part of the microprocessor 21 and may communicate with other components of the microprocessor 21, such as a CPU, without utilizing an external bus or other electronic coupling. Conversely, as used herein, “external memory” refers to memory requiring the use of a bus external to the microprocessor 21, or other form of electronic coupling, to communicate with the microprocessor 21.

To enable the partitioning of system 10, the microprocessor 21 is capable of preventing outside attackers or agents from monitoring the internal bus of the microprocessor 21. In addition, because security routines and critical software is preferably maintained in a tamper-proof state, such routines are stored in the internal flash memory 23. As a result, data stored in the internal flash memory 23 and the internal RAM 25 of the microprocessor cannot be externally queried or otherwise tampered with. In addition, the execution of software stored in the internal flash memory 23 utilizes internal RAM 25 to prevent attackers from changing the outputs of security routines. In general, the types of software preferably stored upon internal flash memory 23 include, but are not limited to, boot loader software, self test software, cryptographic services software, key management services software, memory management services software, finite state machine control software, message processing software, device management software, flash file system software, low level interrupt management software, and hot functions.

Specifically, boot loader software includes any and all software operating to initialize the hardware forming system 10 and facilitate the boot up of system 10. The self test software operates to perform diagnostics on external memory, such as external RAM 27 and external flash memory 29, to detect tampering with the external memory.

Cryptographic services software includes any and all software the operation of which is directed to, but not limited to, performing Elliptic Curve Public Key Validation (ECPKV), an Elliptic Curve Digital Signature Algorithm (ECDSA), a Secure Hash Algorithm (SHA-1), Elliptic Curve Key Generation (ECGEN), Elliptic Curve Menezes, Qu, Vanstone (ECMQV) Key Establishment Schemes, Two Key Triple DES-CBC algorithms, and Hash based Message Authentication Code (HMAC). Key management services software operates to maintain and manipulate cryptographic keys.

Finite state machine control software operates to determine a state vector for the system. Message processing software operates with an external host, such as a personal computer (PC), to perform address decoding, message routing, and to verify the integrity of incoming data. Device management software performs tasks related to the management of devices including, but not limited to, flash memory management (both internal and external), host communications (such as USB, backup ports and keypad interaction), system timers and events, and an external real time clock. Flash file system software operates to manage the flash memory cache. Lastly, hot functions consist of programs and sub-programs with a need to be executed more quickly than can be achieved when executing them on external memory 27, 29.

As noted, the aforementioned security routines and critical software that require protection against tampering are stored in internal flash memory 23. In addition, data, other than data forming software components, are likewise stored in internal flash memory 23. Such data includes, but is not limited to, cryptographic keys, protected parameters, and state registers. Cryptographic keys include, but are not limited to public, secret, and private keys. Protected parameters include, but are not limited to, maximum settable postage and printing parameters in the instance that the system 10 forms a part of a PSD. Likewise, state registers may include data indicating whether money has been spent.

The remaining elements of the application to be executed in system 10 can be stored in the external RAM 27 and external flash memory 29. Examples of such elements include, but are not limited to, business logic, postal configurations, Postage Data Record state and inventory management, image inventory management, font management, data matrix encoding, printing routines, and user interface routines.

In addition to the physical partitioning of sensitive data and software in internal memory 23, 25, various exemplary methodologies can be employed to prevent unwanted access to data and software stored on internal memory 23, 25 configured in accordance with system 10. These methodologies serve to add another level of security to system 10.

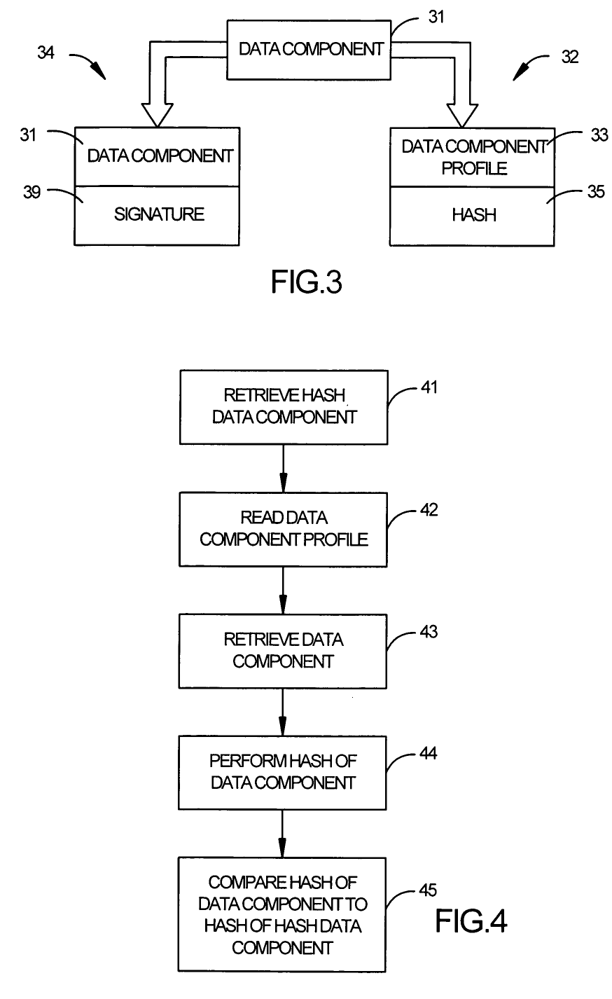

With reference to FIG. 3, there are illustrated two exemplary embodiments of derivatives of data component 31 that can be utilized to provide added security to the system 10. Specifically, as described more fully below, data component 31 can be used to generate a hash data component 32 and a signed data component 34. Data component 31 can be any data, including software components, stored on external memories 27, 29 and accessed by the microprocessor 21. Were the microprocessor 21 to retrieve a data component 31 from an external memory 27, 29 and proceed to execute the code, or otherwise manipulate the data, forming data component 31, the integrity of the processes executed on the microprocessor 21 could be jeopardized. Specifically, if a data component 31, containing nefarious code were transferred from external memory 27, 29 to within the microprocessor 21 and executed, the data component 31 could operate to corrupt the data stored in internal memory 23, 25.

In a first exemplary embodiment, hash data component 32 is formed of a data component profile 33 and a hash 35. Both the data component profile 33 and the hash 35 are derived, in whole or in part, from data component 31. For example, data component profile 33 is formed of data describing one or more attributes of the data component 31. Such attributes include, but are not limited to, the name of the data component 31, the date of creation of the data component 31, and the length of the data component 31. As is evident, the hash data component profile 32 contains data describing the data component 31. Hash 35 is formed of a hash of the data component 31 created by the application of a hash algorithm to the contents of data component 31.

With reference to FIG. 4, there is illustrated an exemplary embodiment of a method by which the hash data component profile 33 can be utilized to provide security to system 10. In operation, at box 41, the microprocessor 21 retrieves the hash data component 32. Typically the hash data component 32 will reside on the same memory device as the data component 31 from which it is derived. At box 42, an examination of the data component profile 33 is performed and a determination is made if access to the data component 31 is desired. For example, a check can be performed to determine if the version of the data component 31 is the desired version. Note that such an evaluation can be performed without accessing data component 31. If it is determined that the data component 31 is to be accessed, at box 43, data component 31 is retrieved.

Once retrieved, at box 44, a hash algorithm is applied to the data component 31 to produce a hash. Lastly, at box 45, the computed hash is compared to the hash 35. If the computed hash and the hash 35 are equal, data component 31, as accessed, has not been altered and can be utilized by the microprocessor 21. Note that while this exemplary methodology involves accessing and performing operations on data component 31, it does not involve the execution of data component 31. As a result, in the event that execution of data component 31 would comprise a breach of security, such a breach is averted.

With continued reference to FIG. 3, there is illustrated an alternative exemplary embodiment by which additional security may be obtained when operating system 10. As noted above, data component 31 can be used to generate a signed data component 34. Signed data component 34 is formed of a recitation of data component 31 to which has been appended a signature 39. Signature 39 serves to encrypt the data component 31. Unlike the method illustrated in FIG. 4, use of the signed data component 34 does not involve accessing a profile of the data component 31. Rather, the inclusion of a signature 39 serves to verify the authenticity of the data component 31 forming a part of signed data component 34.

In addition to appending either a hash or a signature to data component 31 in order to provide a level of security when accessing, executing, or otherwise manipulating data component 31, exemplary embodiments of the invention make use of various techniques to leverage the partitioning of secure data and code in the internal memory 23, 25 from the external memory 27, 29 to provide security. In one exemplary embodiment, only code stored in internal memory 23, 25, preferably internal flash memory 23, is permitted to call or otherwise invoke code stored in either external flash memory 29 or external RAM 27. The implementation of such a constraint operates to prevent the program flow between code located internally or externally to be interrupted.

In an alternative exemplary embodiment, code operating or otherwise executed on internal flash memory 23 can authenticate calls or invocations from code executed in external memories 27, 29. In an exemplary embodiment, there is stored in internal memory 23, 25 the address ranges whereat is stored external code, such as that executed on or from external memories 27, 29. When such external code makes a request of code stored in internal memories 23, 25, the external code places the return address to which it desires control to be passed back to into a memory stack. The return address is therefore an address within the range of memory locations, or registers, within which is stored the external code. By accessing the address ranges stored in internal memories 23, 25, it is possible to compare the return address placed on the stack by an external calling program with address ranges of external code that is permitted to access internal code. If the return address retrieved from the stack does not fall within a permitted address range, access to the operation of internally stored code is restricted. In a similar manner, jump tables can be stored in internal flash memory 23. Jump tables form look up tables of addresses that are accessed when first a routine or function invokes a second routine. By maintaining the jump tables in internal flash memory 23, control is restricted to being passed to only memory locations specified in the secure jump tables.

In addition to the above noted exemplary methods, code and other data stored in external memories 27, 29 can be locked via the operation of internal flash memory 23. In an exemplary embodiment, a computing device, such as central processing unit (CPU) 51, residing within the microprocessor 21 can operate to lock data and code in external memories 27, 29. In an exemplary embodiment, CPU 51 repeatedly computes one or more hashes of one or more code or data elements stored in external memories 27, 29. The computed hashes can be stored in internal RAM 25 or internal flash memory 23. As a result, the stored hashes are secure.

From time to time, the CPU 51 can recompute a hash or hashes of one or more code or data elements stored in external memories 27, 29 and compare the resulting hashes to those previously computed and stored in internal memory 23, 25. In the event that the newly computed hashes do not match the previously computed hashes, unwanted corruption of some code or data element stored in external memory 27, 29 has occurred and appropriate security precautions can be enacted. As is evident, when code or data is legitimately changed upon external memory 27, 29, such as by operation of the CPU 51 executing code stored in internal flash memory 23, previously computed hashes of the changed code can be recomputed.

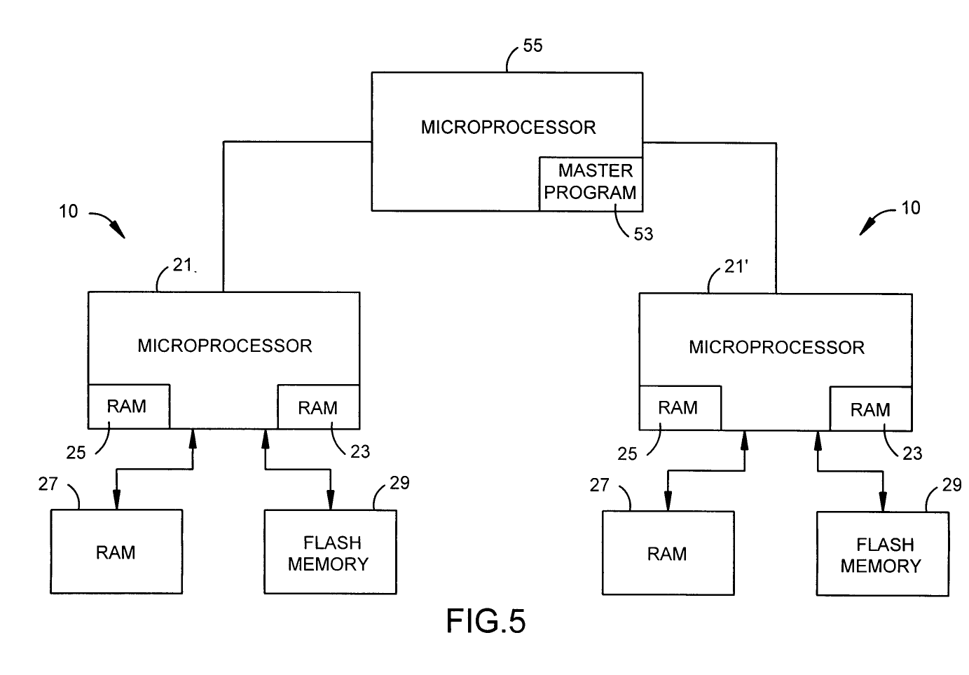

With reference to FIG. 5 there is illustrated an exemplary embodiment of a configuration whereby more than one system 10 can be coupled. Each of microprocessors 21, 21′ forming part of a system 10 are coupled to a microprocessor 55. Microprocessor 55 can function as either a secure or non-secure microprocessor. A master program 53 is stored in a memory coupled to microprocessor 55. Master program 53 operates to direct and coordinate the operations of each microprocessor 21, 21′.

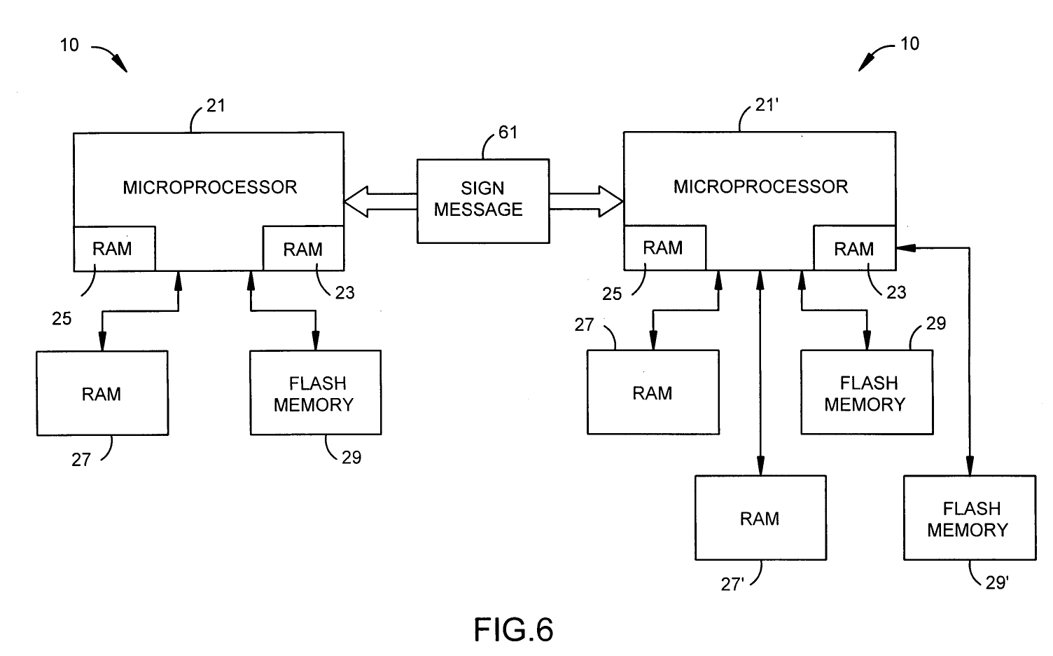

With reference to FIG. 6, there is illustrated an alternative exemplary embodiment whereby more than one system 10 can be coupled. As illustrated, microprocessor 21 is coupled to at least one other microprocessor 21′. The two microprocessors 21, 21′ communicate via an operating system (O/S) that supports microprocessor to microprocessor communication. In one exemplary embodiment, signed messages 61 are exchanged between the microprocessors 21, 21′ to facilitate communication. In addition, one will note that a single microprocessor 21′ can be coupled to multiple external RAMs 27, 27′ as well as multiple external flash memories 29, 29′.

The apparatus of the invention provides for the creation and operation of a PSD with a cost of production of approximately ten dollars. While less costly than existing alternatives requiring physical barriers to tampering, the apparatus of the invention operates to maintain the required security of data and software. In addition, the exemplary methodologies of the invention serve to provide an added level of security independent of additional hardware modifications.

While certain of the embodiments have been described in terms of flash memory storage of program instructions, the embodiments can alternatively be utilized with other appropriate storage technology such as RAM storage, EEPROM storage, ROM storage or mirrored RAM storage that mirrors flash when running.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A postal security device (PSD) comprising:
a microprocessor comprising an internal random access memory (RAM) and an internal memory comprising at least one secure datum of said PSD; and
at least one external memory coupled to said microprocessor comprising at least one non-secure datum and not comprising one of said at least one secure datum.

2. The PSD of claim 1 wherein said internal memory comprises internal flash memory and said at least one secure datum comprises at least one of a boot loader software, a self test software, a cryptographic services software, a key management services software, a memory management services software, a finite state machine control software, a message processing software, a device management software, a flash file system software, a low level interrupt management software, and a hot functions.

3. The PSD of claim 1 wherein said at least one non-secure datum comprises at least one of a business logic software, a postal configuration, a Postage Data Record state, an inventory management software, an image inventory management software, a font management software, a data matrix encoding software, a printing routine, and at least one user interface routine.

4. The PSD of claim 1 wherein said at least one external memory comprises at least one of an external RAM and an external flash memory.

5. The PSD of claim 1 comprising a hash data component comprising a data component and a hash of said data component stored in said at least one external memory.

6. The PSD of claim 1 comprising a signed data component stored in said at least one external memory.

7. The PSD of claim 1 wherein a jump table is stored in at least one of said internal RAM and said internal flash memory.

8. The PSD of claim 1 wherein an address range of said at least one non-secure datum is stored in at least one of said internal RAM and said internal flash memory.

9. A method of securing at least one secure datum in a postal security device (PSD) comprising:
storing said at least one secure datum of said PSD in an internal flash memory of a microprocessor; and
storing at least one non-secure datum in an external memory coupled to said microprocessor wherein said external memory does not comprise one of said at least one secure datum.

10. The method of claim 9 wherein storing said at least one secure datum comprises storing at least one of a boot loader software, a self test software, a cryptographic services software, a key management services software, a memory management services software, a finite state machine control software, a message processing software, a device management software, a flash file system software, a low level interrupt management software, and a hot functions.

11. The method of claim 9 wherein storing said at least one non-secure datum comprises storing at least one of a business logic software, a postal configuration, a Postage Data Record state, an inventory management software, an image inventory management software, a font management software, a data matrix encoding software, a printing routine, and at least one user interface routine.

12. The method of claim 9 comprising:
retrieving a hash data component from said external memory said hash data component comprising a data component profile and a first hash;
retrieving a data component associated with said hash data component;
computing a second hash of said data component; and
utilizing said data component if said first hash is equivalent to said second hash.

13. The method of claim 12 wherein utilizing comprises executing said data component on said microprocessor.

14. The method of claim 9 comprising:
retrieving a signed data component comprising a data component and a signature from said external memory;
authenticating said signature; and
utilizing said data component of said signed data component if said signature is authenticated.

15. The method of claim 9 comprising:
computing a first hash of said at least one non-secure datum stored in said external memory and storing said first hash in said internal flash memory; and
computing a second hash of said at least one non-secure datum stored in said external memory and comparing said second hash to said first hash.

16. The method of claim 9 comprising storing at least one jump table in said internal flash memory.

17. An apparatus comprising:
a first microprocessor comprising an internal random access memory (RAM) and an internal flash memory in which is stored at least one secure datum of a postal security device (PSD) said first microprocessor coupled to at least one external memory comprising at least one non-secure datum and not comprising one of said at least one secure datum; and
a second microprocessor comprising an internal RAM and an internal flash memory in which is stored at least one secure datum of said PSD said second microprocessor coupled to at least one external memory comprising at least one non-secure datum and not comprising one of said at least one secure datum;
wherein an operation of said first microprocessor is coordinated with an operation of said second microprocessor via a coupling.

18. The apparatus of claim 17 wherein said first microprocessor is coupled to said microprocessor via a third microprocessor on which is executed a master program for directing said operation of said first microprocessor and said operation of said second microprocessor.

19. The apparatus of claim 17 wherein said first microprocessor and said second microprocessor communicate via an exchange of signed messages.
